(19) United States
(12) Patent Application Publication
(10) Pub. No.: US 2015/0170825 A1
(43) Pub. Date: Jun. 18, 2015

(54) Planar Transformer and Electrical Component

(71) Applicant: Horst Kröckel, Bamberg (DE)

(72) Inventor: Horst Kröckel, Bamberg (DE)

(21) Appl. No.: 14/571,277

(22) Filed: Dec. 15, 2014

(30) Foreign Application Priority Data
Dec. 16, 2013 (DE) 102013226066.0

(51) Int. Cl. H01F 27/28

(52) U.S. Cl. CPC H01F 27/288; H01F 27/2804; H01F 2027/2819

(57) ABSTRACT

A planar transformer includes a printed circuit board, at least two conductor tracks, a base plate, and a recess that is formed in the base plate. A shroud that is formed from an at least partially electrically conductive material is arranged in the recess. The shroud is electrically connected to the printed circuit board.

This application claims the benefit of DE 10 2013 226 066.0, filed on Dec. 16, 2013, which is hereby incorporated by reference in its entirety.

### BACKGROUND

The present embodiments relate to a planar transformer.

The prior art discloses planar transformers that are realized in electrical components (e.g., in the form of circuits that are printed onto printed circuit boards). This kind of planar transformer may have a flux return space beneath the printed circuit board. The printed circuit board has a continuous, rectangular opening with a circumferential contact area. Base plates that are composed of sheet metal and are electrically connected to the surface of the printed circuit board may be arranged beneath the printed circuit boards. The base plate has a cuboidal recess that forms and delimits the flux return space. High-frequency magnetic waves may escape from the flux return space. The magnetic waves are captured by other electrical structures (e.g., other planar transformers) on the printed circuit board or in the area surrounding the printed circuit board and possibly cause interference there.

In order to avoid the problem of the magnetic field escaping from the flux return space and the interference with further structures caused by this, contact between the printed circuit board and the base plate is to be established in a circumferential manner. This has been achieved by the base plate having been adhesively bonded to the printed circuit board with the aid of a conductive adhesive. Suitable adhesives include epoxy adhesives with a high content of silver particles. In order to provide that the silver particles come into contact with the surface of the printed circuit board and the base plate, the copper conductor track structures of the printed circuit board are nickel-plated and then coated with a layer of flash gold. The base plate is likewise initially nickel-plated and then provided with a flash gold surface.

This procedure is time-consuming and cost-intensive. In addition, there is a risk of the printed circuit board becoming detached from the base plate due to premature breakdown of the conductive adhesive. This delamination may be caused either by thermal, mechanical or chemical effects on the conductive adhesive. Parts of the electrical component may prematurely corrode and wear away owing to the flash gold surface with the partially interrupted gold layer on the nickel layer. Corrosion may also occur due to the ingress of liquid into the flux return space since the flux return space may not be adhesively bonded to the printed circuit board in a hermetically sealed manner.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved planar transformer in which high-frequency magnetic waves are prevented from escaping from the flux return space is provided.

In the case of a planar transformer, a connection between the base plate and the printed circuit board may be used to prevent the propagation of high-frequency magnetic waves out of the flux return space and in this way to avoid interference with other electrical components (e.g., further, adjacent planar transformers). Complicated and unreliable adhesive bonding of the base plate and the printed circuit board is not necessary with this connection of the components.

According to one or more of the present embodiments, a shroud is arranged in the recess in the base plate. The flux return space is formed within the shroud and is accordingly delimited by the shroud. The shroud then completely shields the conductor tracks from the base plate and in this way prevents the magnetic field from escaping from the flux return space. Electrically conductive materials (e.g., a copper sheet) are suitable for the shroud. The shroud is electrically connected (e.g., soldered in a circumferential manner) to the printed circuit board, and in this way, the printed circuit board makes contact with the shroud in a reliable manner. The printed circuit board may likewise be mounted on the base plate by simple soldering, without the use of a conductive adhesive.

In order to fix the shroud on the printed circuit board before soldering, the shroud may have lug-like or nail-like pins that are inserted into holes in the printed circuit board. Depending on the design of the pins, the holes may be produced in different sizes, so that the pins may be either plugged or pressed into the holes.

As described above, the shroud and the base plate may be in the form of two separate components. As an alternative, the shroud and the base plate may be integrally formed. The shroud is integrated into the base plate, for example. The connection of the shroud or of the base plate to the printed circuit board may be formed over a partial area in this embodiment (e.g., as a circumferential contact edge or in the form of contact springs). With this type of connection, the base plate is pressed onto the printed circuit board via the shroud. A further possibility is to establish the connection using insulation ribs or attenuation ribs that are formed on the base plate. A gap is respectively formed between the ribs. The gap attenuates and in this way largely prevents the propagation of the magnetic field out of the flux return space owing to the change in the surface inductance of rib and gap.

A planar transformer includes at least a printed circuit board, at least two conductor tracks, a base plate, and a recess that is formed in the base plate. A shroud that is formed from an at least partially electrically conductive material is thus arranged in the recess. The shroud is electrically connected to the printed circuit board.

In one exemplary embodiment, the printed circuit board and the base plate are produced from a tin-plated copper sheet. The printed circuit board has a continuous, rectangular opening above which the at least two conductor tracks are arranged. The base plate is arranged beneath the printed circuit board. The base plate has a recess (e.g., a cuboidal recess). The recess in the base plate is open on one side face (e.g., facing the conductor tracks). In one embodiment, a recess that is open on two opposite side faces is provided.

The opening in the printed circuit board and the recess in the base plate are, for example, milled out. The base areas of the opening and of the recess are of equal size, and the printed circuit board and the base plate are arranged one on the other such that the printed circuit board and the base plate are arranged congruently one above the other.

According to one or more of the present embodiments, the shroud is arranged in the recess. The shroud forms the flux return space in an interior of the shroud. The shroud is inserted into the recess in the base plate through the opening in the printed circuit board. The shroud thus covers the conductor tracks with respect to the base plate. The shroud may be in the form of a flat cuboid that is open on one side and is open in the direction of the conductor tracks and closed in the direction of the base plate. In this case, the shroud completely shields the conductor tracks and delimits the flux return space (i.e., the shroud does not have any openings, gaps, etc.).

The shroud may be formed from an electrically conductive metal sheet (e.g., a copper sheet). The metal sheet may be shaped, for example, by folding or bending edges of the metal sheet or deep-drawing. In one embodiment, the shroud is tin-plated (i.e., has a tin layer on a surface).

In one embodiment of the planar transformer, the shroud and the base plate are formed in two parts (e.g., in the form of separate components). In this case, the shape of the shroud may complement the shape of the recess in the base plate. The shroud and the base plate are substantially spaced apart from one another in the assembled state. Deformation of the base plate or of the printed circuit board when the components are connected may be avoided in this way. The shroud therefore advantageously has smaller dimensions than the recess in the base plate. For example, the shroud has a lower depth or height and also a smaller width than the recess.

According to one or more of the present embodiments, the shroud is electrically connected to the printed circuit board. In one embodiment, the shroud is fixed to the printed circuit board. The fixing may be implemented as circumferential soldering. The circumferential soldering is implemented over the full area in an edge or contact region around the opening in the printed circuit board. In one embodiment, a tin paste may be applied to the printed circuit board circumferentially around the opening. The tin paste is used as a circumferential solder edge. The circumferential soldering establishes full contact between the components.

The printed circuit board may also be electrically conductively connected to the base plate by a solder connection. By way of example, the shroud may be soldered to the printed circuit board, and the printed circuit board may be soldered to the base plate either at the same time or in succession.

In order to securely connect the shroud to the printed circuit board as early as after the shroud is inserted into the opening and before the shroud is soldered, the shroud has at least one fixing device for additional fixing to the printed circuit board in one embodiment. The shroud has in each case one fixing device on two opposite sides. Embodiments with more than two fixing devices (e.g., a plurality of fixing devices that are laterally offset) may likewise be implemented. The fixing devices may be formed on the edge of the shroud that is oriented toward the printed circuit board (e.g., as lug-like plug-in pins). The fixing device may likewise be in the form of nail-like press-in pins.

The printed circuit board has at least one hole. In the assembled state, the hole may be arranged so as to correspond to the at least one fixing device that is formed on the shroud. The number of holes in the printed circuit board may correspond to the number of fixing devices on the shroud. The arrangement of the holes may further correspond to the arrangement of the fixing device on the shroud. The fixing device may be inserted into the holes. If the fixing devices are in the form of lug-like plug-in pins, the fixing devices are simply inserted into the holes and, in the process, bent over or folded over in the assembled state.

In this embodiment, the size of the holes advantageously corresponds at least to the size of the plug-in pins, so that the plug-in pins may be easily inserted into the holes. This manner of fixing is suitable primarily for manufacture of the planar transformer by hand.

In contrast, the holes in an embodiment of the fixing devices as nail-like press-in pins are slightly smaller than the press-in pins. The press-in pins are then pressed into the holes owing to an application of force during manufacture. The press-in pins may be suitable for machine manufacture since the application of force is greater.

Another embodiment of the planar transformer makes provision for the shroud to be integrated into the base plate. The shroud and the base plate are then integrally formed (e.g., from a single copper sheet). The component base plate/shroud has a recess in this embodiment too. In this case, the recess forms the flux return space.

In this embodiment, the component, which is formed from the base plate and shroud, has a circumferential partial-area connection to the printed circuit board. The partial-area connection is, for example, in the form of a circumferential contact edge or contact spring on the base plate. In this case, the contact edge and the contact spring are formed on the base plate such that, when the planar transformer is assembled, the contact edge or the contact spring is pushed into the material of the printed circuit board. Secure and complete contact is made between the printed circuit board and the base plate by way of the shroud in this embodiment too. The contact edge may, for example, be in the form of a polygonal (e.g., triangular or prismatic) or round shaping on the base plate. In addition, the base plate may be soldered to the printed circuit board, once again in a circumferential manner.

In another embodiment of the circumferential, partial-area connection to the printed circuit board, the base plate has attenuation ribs. The attenuation ribs attenuate the magnetic field that escapes from the flux return space and therefore insulate the flux return space. At least two attenuation ribs are advantageously formed. A respective gap is formed between the attenuation ribs. The individual attenuation ribs are soldered to the printed circuit board in each case in a circumferential manner.

An electrical component having at least one planar transformer is also provided. The at least one planar transformer is formed in accordance with the description above. By way of example, a plurality of planar transformers according to one or more of the present embodiments may be mounted on a printed circuit board at a distance from one another. Covering the conductor tracks by the shroud according to one or more of the present embodiments may prevent the magnetic field from escaping from the flux return spaces and interfering with the adjacent planar transformers. In addition, yet further electrical components may also be arranged on the printed circuit board.

The electrical component may be in the form of a high-frequency amplifier for magnetic resonance devices. The electrical component is suitable for transistor amplifiers and also for adapting the signal synthesis arrangement and the antenna arrangements, which may also contain switchover devices, of amplifiers of this kind. The electrical component may be employed in medical imaging systems or spectrum-forming magnetic resonance systems.

The present embodiments provide the following advantages. Adhesive bonding of the components of the planar transformer is no longer necessary. The preparation steps for processing the adhesive (e.g., the application of the nickel and gold layers) are therefore dispensed with. Normal tin-plated printed circuit boards and tin-plated or nickel-plated base plates may advantageously be used. This results in large time and cost savings with respect to production. This also eliminates the risk of delamination of the adhesively bonded components owing to the premature breakdown of the conductive adhesive due to thermal, mechanical and chemical effects.

The connection of the printed circuit board to the base plate without additional gold coating may prevent local corrosion of the components that has occurred to date on account of the combination of the incompletely closed flash gold layer on the nickel-plated surfaces.

The flux return spaces may be hermetically sealed off by the use of the shroud according to one or more of the present embodiments, so that there is no longer a risk of corrosion due to the ingress of liquid.

### BRIEF DESCRIPTION OF THE DRAWINGS

The present embodiments will be described in greater detail below with the aid of the figures, where only the features that are necessary for understanding are illustrated.

FIG. 1 shows a schematic illustration of one embodiment of a longitudinal section through a planar transformer;

FIG. 2 shows a schematic illustration of a cross section through the planar transformer of FIG. 1;

FIG. 3 shows a schematic illustration of a longitudinal section through one embodiment of an electrical component having two planar transformers;

FIG. 4 shows a schematic illustration of a shroud in a first embodiment;

FIG. 5 shows a schematic illustration of the shroud in a second embodiment;

FIG. 6 shows a schematic illustration of the shroud in a third embodiment;

FIG. 7 shows a schematic illustration of a longitudinal section through the planar transformer according to a second embodiment;

FIG. 8 shows a schematic illustration of a cross section through the planar transformer of FIG. 7;

FIG. 9 shows a schematic illustration of a longitudinal section through the planar transformer in a third embodiment;

FIG. 10 shows a schematic illustration of a cross section through the planar transformer of FIG. 9;

FIG. 11 shows a schematic illustration of a longitudinal section through the planar transformer in a fourth embodiment;

FIG. 12 shows a schematic illustration of a cross section through the planar transformer of FIG. 11; and

FIG. 13 shows a schematic illustration of a longitudinal section through the planar transformer in a fifth embodiment.

### DETAILED DESCRIPTION

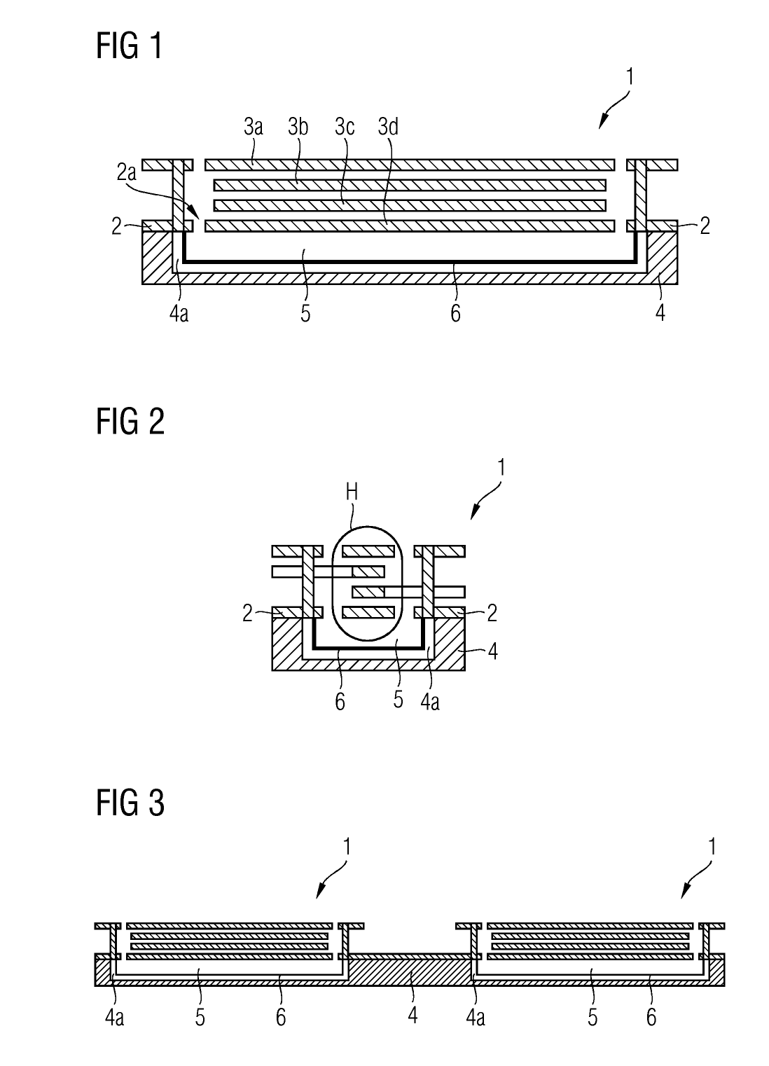

FIGS. 1, 7, 9, 11 and 13 each show a longitudinal section through an embodiment of a planar transformer 1. FIGS. 2, 8, 10 and 12 each show a cross section through the planar transformer 1. The basic design of the planar transformer 1 according to one or more of the present embodiments will be described in the text that follows.

The planar transformer 1 includes a printed circuit board 2 having an opening 2a that is milled out in a rectangular manner. The printed circuit board 2 is produced from a copper sheet with a tin-plated surface and serves to support the further components of the planar transformer 1. The planar transformer 1 further includes four windings that are in the form of conductor tracks 3a to 3d and are arranged one above the other. During operation of the planar transformer 1, a magnetic field H forms around the windings. The position of the magnetic field is schematically indicated by an oval (e.g., see FIG. 2).

A base plate 4 of the planar transformer 1 is arranged below the printed circuit board 2. The base plate 4 is produced from a copper sheet. As will be explained in the text that follows, the printed circuit board 2 and the base plate 4 are electrically conductively connected to one another. A flat, cuboidal recess 4a is milled out of the base plate 4. In this case, the base areas of the recess 4a in the base plate 4 and the opening 2a in the printed circuit board 2 are of equal size and are arranged one above the other.

According to one or more of the present embodiments, a shroud 6 that is composed of an at least partially electrically conductive material is arranged in the recess 4a. The shroud 6 forms, in an interior of the shroud 6, a flux return space 5 of the planar transformer 1. The magnetic field of the planar transformer 1 extends into the flux return space 5. The conductor tracks 3a to 3d are shielded from the base plate 4 by the shroud 6. This prevents the magnetic field escaping from the flux return space 5. The shroud 6 is electrically conductively connected to the printed circuit board 2 and fixed to the printed circuit board according to one or more of the present embodiments.

FIG. 1 shows a schematic illustration of a longitudinal section through the planar transformer 1 in a first embodiment. In this embodiment, the shroud 6 and the base plate 4 are in the form of separate components.

During production of the planar transformer 1, a solder paste is applied to the printed circuit board 2 circumferentially around the opening 2a. The shroud 6 is then inserted into the opening 2a and soldered to the printed circuit board 2 along the circumferential solder paste edge. The printed circuit board 2 is then placed onto the base plate 4 by way of the shroud 6, where the shroud 6 is inserted so as to be arranged in the recess 4a. The shroud 6 is smaller than the recess 4a, and therefore, the shroud 6 is at a distance from the base plate 4 in the assembled state. The full-surface and circumferential solder connection of the base plate 4 to the shroud 6 and the printed circuit board 2 provides that secure contact is made between the components.

FIG. 2 shows a cross section through the planar transformer 1 from FIG. 1. The full-surface and circumferential connection of the components and also the spacing between the shroud 6 and the base plate 4 are shown, for example.

FIG. 3 shows a schematic illustration of a longitudinal section through an electrical component having two planar transformers 1 according to one or more of the present embodiments, where the planar transformers 1 correspond to the embodiment described in FIGS. 1 and 2. The planar transformers 1 are arranged on a common base plate 4 in a manner spaced apart from one another and have a common printed circuit board 2. Accordingly, the base plate 4 has two recesses 4a. A shroud 6 is arranged in each of the two recesses 4A. The planar transformers 1 are arranged in a manner spaced apart from one another. The covering of the conductor tracks with respect to the base plate 4 prevents high-frequency magnetic waves escaping from the flux return spaces 5 and interfering with the other planar transformer 1.

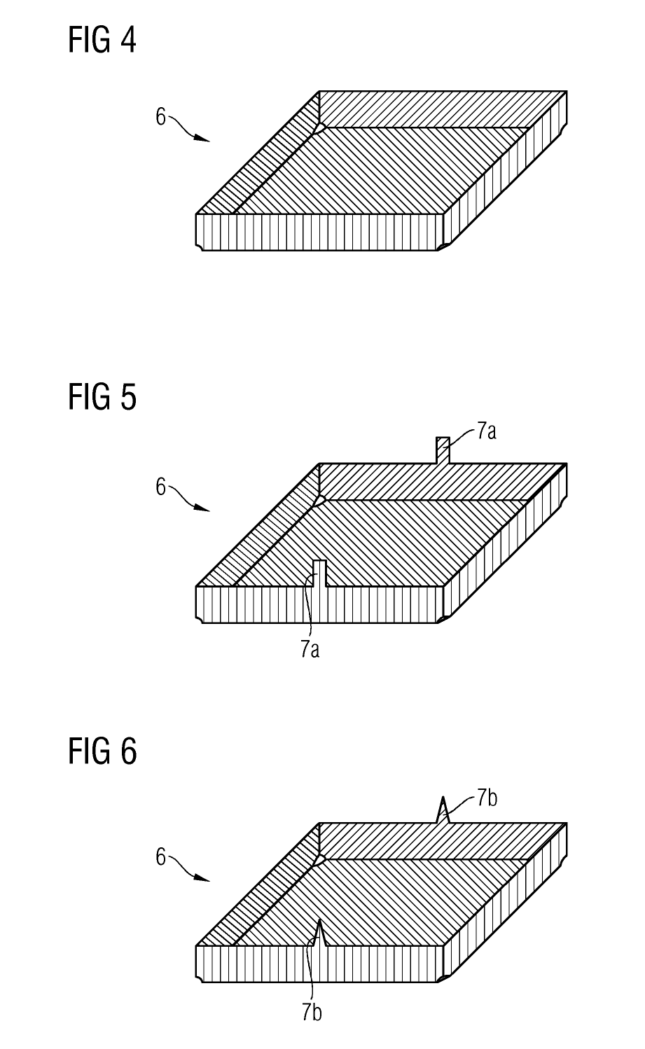

FIGS. 4, 5 and 6 show the shroud 6 in different embodiments. In all of the embodiments, the shroud 6 is in the form of a flat cuboid with an open side face. The shroud 6, which is composed of a thin copper sheet, is folded or bent at edges of the shroud 6. In order to make it easier to fold or bend the edges of the metal sheet and to prevent unevennesses in the surfaces of the shroud 6, the shroud 6 has open corners or cutouts at the corners. The shroud 6 is open in the direction of the conductor tracks (see FIGS. 1 and 2).

In FIG. 4, the shroud 6 is shown in an embodiment without additional fixing devices. In contrast, FIGS. 5 and 6 show the shroud 6 with, in each case, two additional fixing devices 7a and 7b at the upper edges on opposite sides in order to be fixed to the printed circuit board. In FIG. 5, the fixing devices are in the form of rectangular plug-in pins 7a. The plug-in pins 7a are inserted into holes in the printed circuit board and bent over like lugs. According to FIG. 6, the shroud 6 has two fixing devices that are in the form of triangular press-in pins 7b. The press-in pins 7b are pressed into smaller holes in the printed circuit board in the manner of nails.

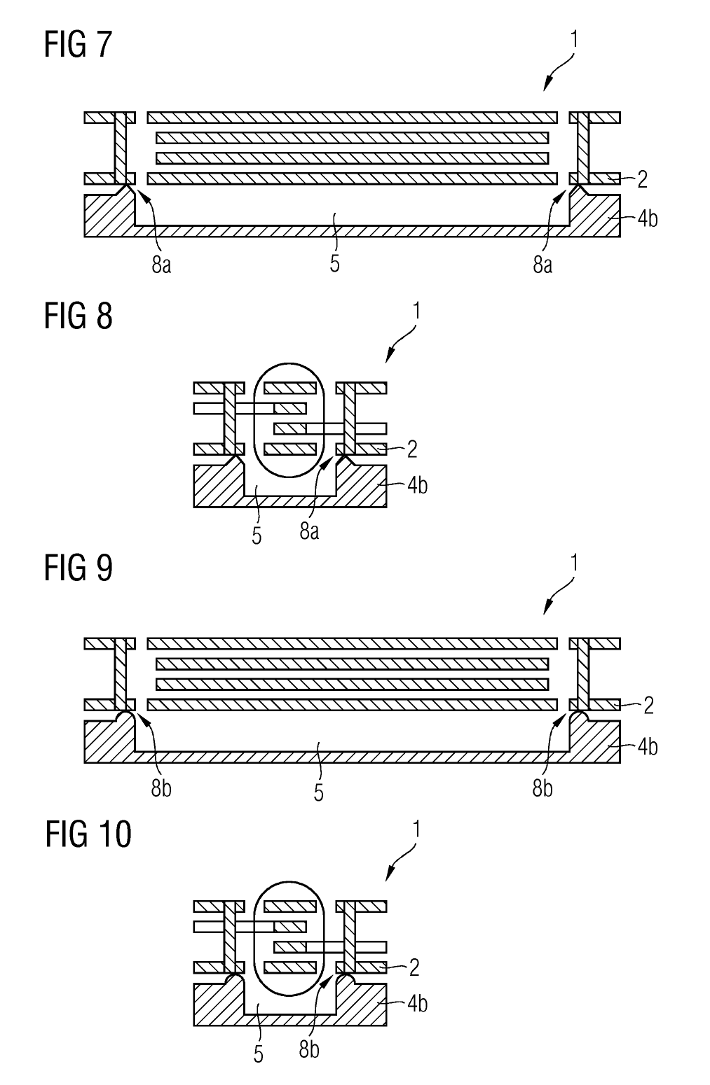

An alternative variant of the planar transformer 1 according to one or more of the present embodiments is shown in various embodiments in FIGS. 7 and 8, 9 and 10, 11 and 12 and also 13. In the embodiments, the base plate and the shroud are integrally formed as one component 4b (e.g., composed of a copper sheet). The flux return space 5 is then accordingly formed within the component 4b and delimited by the component.

FIG. 7 shows a longitudinal section through one of the further embodiments, and FIG. 8 shows a cross section through one of the further embodiments. The printed circuit board 2 is connected to the component 4b only over a partial surface by a circumferential contact edge 8a. The contact edge 8a is triangular in this case. When the component 4b and the printed circuit board 2 are joined, the tip of the contact edge 8a is pressed into the relatively soft copper material of the printed circuit board 2 and in this way establishes circumferential contact between the base plate or the component 4b and the printed circuit board 2.

FIGS. 9 and 10 show a yet further embodiment of the planar transformer 1. FIG. 9 shows a longitudinal section, and FIG. 10 shows a cross section. The embodiment in FIGS. 9 and 10 corresponds, in principle, to the embodiment in FIGS. 7 and 8 with an integral base plate and shroud, where, however, the circumferential contact edge 8b is round.

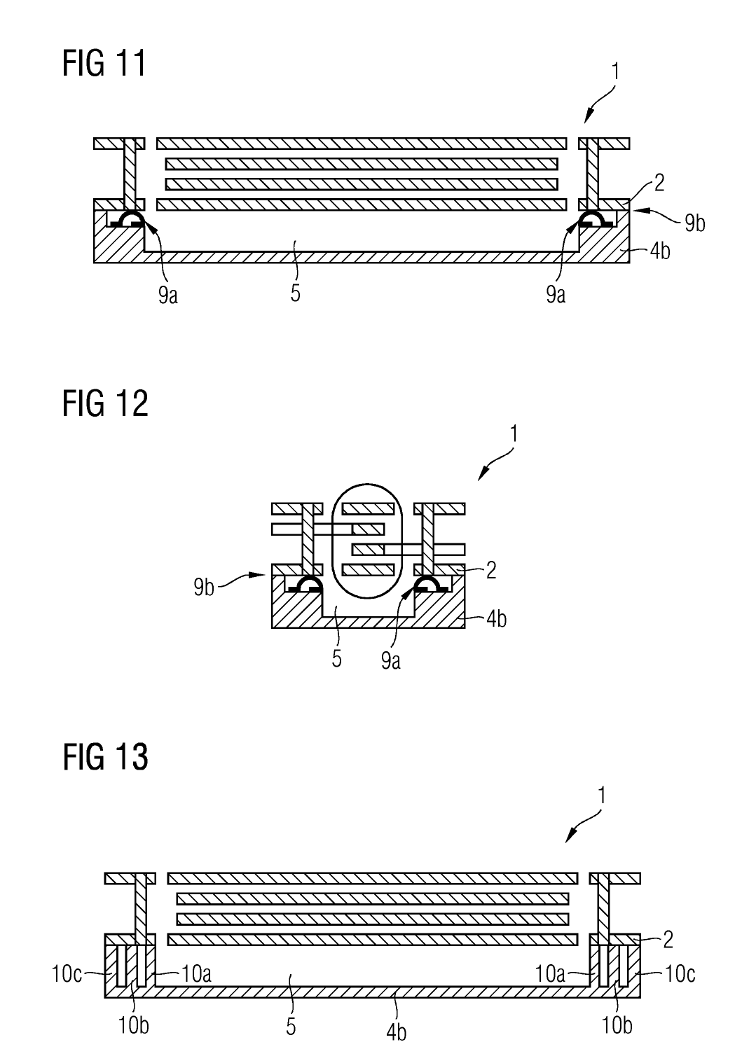

FIGS. 11 and 12 show a further embodiment. FIG. 11 in a longitudinal section, and FIG. 12 is a cross section. Instead of the circumferential contact edge as in FIGS. 7 and 8 and, respectively, FIGS. 9 and 10, a circumferential contact spring 9a is formed for connecting the component 4b to the printed circuit board 2 in this case. When the component and printed circuit board are joined, the contact spring 9a is bent over and pushed into the material of the printed circuit board 2. In addition, the components are still electrically conductively connected by way of a circumferential solder connection 9b.

FIG. 13 shows a further embodiment of a longitudinal section through the planar transformer 1. The component 4b has, at the sides, in each case three circumferential attenuation ribs 10a to 10c. By way of example, the attenuation ribs 10a to 10c are milled into the edges of the component 4b. The attenuation ribs 10a to 10c are soldered to the printed circuit board 2 at ends of the attenuation ribs 10a to 10c. Two empty gaps are formed between the three attenuation ribs 10a to 10c. The different surface inductance in the attenuation ribs 10a to 10c and in the gaps largely prevents the magnetic field from escaping from the flux return space.

Although the invention has been illustrated and described in greater detail by the exemplary embodiments, the invention is not restricted to the disclosed examples. Other variations may be derived from the examples by a person skilled in the art without departing from the scope of protection of the invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A planar transformer comprising:
a printed circuit board;
at least two conductor tracks;
a base plate;
a recess that is formed in the base plate; and
a shroud that is formed from an at least partially electrically conductive material,
wherein the shroud is arranged in the recess, and
wherein the shroud is electrically connected to the printed circuit board.

2. The planar transformer of claim 1, wherein a flux return space is formed in an interior of the shroud.

3. The planar transformer of claim 1, wherein the shroud is formed from an electrically conductive metal sheet.

4. The planar transformer of claim 1, wherein the shroud has smaller dimensions than the recess in the base plate, and the shroud is at a distance from the base plate in an assembled state.

5. The planar transformer of claim 1, wherein the shroud is fixed to the printed circuit board.

6. The planar transformer of claim 5, wherein the fixing is a circumferential soldering.

7. The planar transformer of claim 1, wherein the shroud comprises at least one fixing device for additional fixing to the printed circuit board.

8. The planar transformer of claim 7, wherein the printed circuit board has at least one hole.

9. The planar transformer of claim 1, wherein the shroud is integrated into the base plate.

10. The planar transformer of claim 9, wherein the base plate having the shroud has a circumferential, partial-area connection to the printed circuit board.

11. The planar transformer of claim 10, wherein the partial-area connection is in the form of a contact edge or contact spring on the base plate.

12. The planar transformer of claim 10, wherein the base plate has attenuation ribs.

13. An electrical component comprising:
at least one planar transformer comprising:
a printed circuit board;
at least two conductor tracks;
a base plate;
a recess that is formed in the base plate; and
a shroud that is formed from an at least partially electrically conductive material,
wherein the shroud is arranged in the recess, and
wherein the shroud is electrically connected to the printed circuit board.

14. The electrical component of claim 13, wherein the electrical component is in the form of a high-frequency amplifier for magnetic resonance devices.

15. The electrical component of claim 13, wherein a flux return space is formed in an interior of the shroud.

16. The electrical component of claim 13, wherein the shroud is formed from an electrically conductive metal sheet.

17. The electrical component of claim 13, wherein the shroud has smaller dimensions than the recess in the base plate, and the shroud is at a distance from the base plate in an assembled state.

18. The electrical component of claim 13, wherein the shroud is fixed to the printed circuit board.

19. The electrical component of claim 18, wherein the fixing is a circumferential soldering.

20. The electrical component of claim 13, wherein the shroud comprises at least one fixing device for additional fixing to the printed circuit board.
